(19) United States
(12) Patent Application Publication
(10) Pub. No.: US 2002/0154370 A1
(43) Pub. Date: Oct. 24, 2002

(54) Optic relay unit and terminal station in light transmission system

(76) Inventor: Satoshi Ishii, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 10/124,249

(22) Filed: Apr. 18, 2002

(30) Foreign Application Priority Data
Apr. 19, 2001 (JP) 2001-120999

(51) Int. Cl. H04B 10/08; H04B 10/02

(52) U.S. Cl. 359/177; 359/110

(57) ABSTRACT

An optic relay unit includes (a) an excitation light source to which a predetermined inherent frequency is assigned, (b) an optical amplifier arranged in a transmission line through which a main signal light having a predetermined wavelength is transmitted, to receive the main signal light, the optical amplifier being excited by an excited light emitted from the excitation light source and amplifying the main signal light, and (c) a fault monitoring unit which generates a fault monitoring signal light modulated with the predetermined inherent frequency and having a wavelength different from the predetermined wavelength of the main signal light, when a fault occurs in the excitation light source, and transmits the fault monitoring signal light to the transmission line.

### BACKGROUND OF THE INVENTION

1. Field of the Invention

The invention relates to an optic relay unit receiving a signal light and amplifying it, a terminal station receiving a signal light through such an optic relay unit, and a light transmission system including such an optic relay unit and a terminal station. The invention relates also to a method of identifying an excitation light source in which a fault occurs, in a light transmission system including a transmission line in which a plurality of optic relay units each including an excitation light source is arranged.

2. Description of the Related Art

In a light transmission system in which a signal light is transmitted through an optical fiber such as an optical fiber composed of quartz, a signal light is reduced in a level thereof in a long transmission distance due to a transmission loss of an optical fiber. Hence, an optic relay unit is generally arranged in a transmission line for amplifying a signal light with an excited light.

As such an optic relay unit, there is known an optic relay unit including Erbium-doped fiber (EDF). The optic relay unit is comprised of an Erbium-doped fiber, and a laser diode (LD) as an excitation light source. A signal light is excited with an excited light emitted from a laser diode, and transmitted through an Erbium-doped fiber with the result that the signal light is amplified.

In a light transmission system including such an optic relay unit as mentioned above, if a fault occurs in an optic relay unit, it would be impossible to accurately transmit a signal light. Hence, it is absolutely necessary to find a fault, if it occurs.

A method of detecting such a fault occurring in an optic relay unit is grouped into a loop-back method and a command response method. In a loop-back method, terminal stations are connected through upward and downward transmission lines in both of which a plurality of optic relay units is arranged. One of the terminal stations transmits a signal light including a fault monitoring signal to an upward transmission line, for instance. The optic relay units return a part of the signal light back to a downward transmission line. The terminal station receives the thus returned signal light, and checks whether a fault occurs in any one of the optic relay units, based on the fault monitoring signal included in the returned signal light. In a command response method, one of the terminal stations transmits a command to a particular optic relay unit, and monitors a response transmitted from the particular optic relay unit.

Apart from the above-mentioned methods, Japanese Unexamined Patent Publication No. 5-336046 (A) has suggested a relay system for amplifying a signal light. The relay system is comprised of a plurality of first optic relay units for optically amplifying a signal light transmitted from a terminal station, and a second optic relay unit for reproducing and relaying the signal light.

FIG. 1 is a block diagram of the first optic relay unit used in the suggested relay system.

As illustrated in FIG. 1, the first optic relay unit is comprised of an optical amplifier 300, a receiver 311, an extracting circuit 312, a monitoring data processor 318, an oscillator 314, a modulation circuit 315, a light source 321, a monitoring circuit 331, an optical separator 341, and an optical synthesizer 342.

The optical separator 341 separates a signal light including a main signal and a fault monitoring signal, received from an upstream optic relay unit or terminal station, into two parts. One of the parts of the signal light is transmitted to the optical amplifier 300, and the other to the receiver 311. The receiver 311 is comprised of a light-receiving device, which converts the signal light received through the optical separator 341 into an electric signal. The optical amplifier 300 is comprised of an Erbium-doped fiber and an excitation light source such as a laser diode, for amplifying the signal light received from the optical separator 341.

The extracting circuit 312 extracts a fault monitoring signal out of the signal light received at the receiver 311. The monitoring circuit 331 detects whether the main signal light is interrupted and whether a fault occurs in an optic relay unit by checking whether an output transmitted from the optical amplifier 300 is reduced and whether a fault occurs in an excitation light source. The monitoring data processor 313 converts data about a fault, transmitted from the extracting circuit 312 or the monitoring circuit 331, into a signal. If the monitoring data processor 313 receives data from the extracting circuit 312, the received data is converted into a signal earlier than data received from the monitoring circuits.

The modulation circuit 315 modulates an amplitude of an output signal transmitted from the oscillator 314, based on the fault data having been converted into a signal by the monitoring data processor 313. The light source 321 is driven by the modulation circuit 315, and converts a fault monitoring signal into a light signal. The optical synthesizer 842 synthesizes the main signal light with the fault monitoring signal light transmitted from the light source 321.

In the relay system including a plurality of the first optic relay units having the above-mentioned structure, if a certain first optic relay unit cannot receive the main signal light from an upstream first optic relay unit or terminal station, or if a fault occurs in a certain first optic relay unit, the monitoring circuit 331 detects it, and transmits fault data to the monitoring data processor 313. The fault data includes detailed information about the fault, and an ID number for identifying a first optic relay unit in which the fault occurred.

On receipt of the fault data from the monitoring circuit 331, the monitoring data processor 313 codes the received fault data into a signal, and transmits the thus coded fault data to the modulation circuit 315. On receipt of the coded fault data, the modulation circuit 315 modulates a light emitted from the light source 321 to cause the light to have a low frequency. As a result, a fault monitoring signal including the fault data is transmitted from the light source 321. The fault monitoring signal transmitted from the light source 321 is synthesized with the main signal light in the optical synthesizer 342, and then, transmitted to a terminal station through the first and second optic relay units located downstream.

A first optic relay unit located downstream receives the main signal light including the fault monitoring signal light and transmitted from the upstream first optic relay unit, at the receiver 311. The extracting circuit 312 extracts fault data out of the received fault monitoring signal light, and transmits the thus extracted fault data to the monitoring data processor 313. If the monitoring data processor 313 receives the fault data from the extracting circuit 312, the monitoring data processor 313 converts the fault data into a signal earlier than other data.

Thus, the fault data indicative of a first optic relay unit in which a fault occurs is transmitted to a second optic relay unit through the downstream first optic relay unit. The second optic relay unit writes the fault data into the main signal light. Hereinafter, the main signal light is transmitted to a terminal station through first and second optic relay units located downstream.

The above-mentioned conventional light transmission system is accompanied with problems as follows.

One of faults of the first optic relay unit illustrated in FIG. 1 is a fault in an excitation light source. In a light transmission system including a plurality of the first optic relay units through which a signal light is transmitted, if a fault occurs in an excitation light source in a certain first optic relay unit, it is necessary to identify the first optic relay unit including an excitation light source in which a fault occurs. However, in accordance with the above-mentioned loop-back method, it would be quite difficult to identify a first optic relay unit including an excitation light source in which a fault occurs, because the loop-back method makes it possible to merely detect a fault in a first optic relay unit by detecting a level of a fault monitoring signal returned back thereto.

It is necessary in the above-mentioned command response method to arrange a circuit of receiving a command and a circuit of transmitting a response, in a first optic relay unit, resulting in complexity in circuits in a first optic relay unit.

The relay system for amplifying a signal light suggested in the above-mentioned Japanese Unexamined Patent Publication No. 5-386046 (A) is accompanied with problems that the suggested relay system merely detects a fault which occurred in an excitation light source, but the terminal station cannot identify an excitation light source in which a fault occurred, and that the relay system cannot detect a fault occurring a forward-excitation type first optic relay unit. In addition, a further problem in the suggested relay system is that the relay system would be necessary to include a circuit for generating a fault monitoring signal in order to know a detail of a fault and identify a first optic relay unit in which a fault occurs. The fault monitoring signal is generated by coding an ID number assigned to each of first optic relay units. As a result, the relay system is unavoidably complex in structure, similarly to the above-mentioned response command method.

Japanese Unexamined Patent Publication No. 5-344073 (A) has suggested an optic relay unit including a first optic amplifier which receives a light signal transmitted through an upward transmission line, amplifies the received light signal by mean of an Erbium-doped fiber, and transmits the amplified light signal to a downward transmission line, a first controller which separates the light signal transmitted from the first optic relay unit, into parts, and detects a monitoring control signal out of the parts of the light signal, a second optic amplifier which receives a light signal transmitted through a downward transmission line, amplifies the received light signal by mean of an Erbium-doped fiber, and transmits the amplified light signal to an upward transmission line, and a second controller which separates the light signal transmitted from the second optic relay unit, into parts, and detects a monitoring control signal out of the parts of the light signal. A bias current to be applied to a laser diode which supplies an excited light to the second optic amplifier is modulated with a certain frequency in accordance with an output signal transmitted from the first controller, and a bias current to be applied to a laser diode which supplies an excited light to the first optic amplifier is modulated with a certain frequency in accordance with an output signal transmitted from the second controller.

Japanese Patent No. 2550855 (B2) (Japanese Unexamined Patent Publication No. 6-326666 (A)) has suggested an optic amplifier including a fiber into which rare earth metal is mixed and which receives a main optic signal as a signal light, a first oscillator which oscillates at a sine wave having a first frequency lower than a low-pass cut-off frequency of the fiber, a second oscillator which oscillates at a sine wave having a second frequency which is lower than a low-pass cut-off frequency of the fiber and different from the first frequency, a switching circuit which receives binary digital data to be multiplexed to the main optic signal, and selects the first or second oscillator in accordance with the received binary digital data, a first excitation light source which emits an excited light having the first frequency, when the switching circuit selects the first oscillator, a second excitation light source which emits an excited light having the second frequency, when the switching circuit selects the second oscillator, an optic synthesizer which synthesizes excited lights emitted from the first and second excitation light sources, to each other, and a wavelength division multiplexing coupler which multiplexes an output light transmitted from the fiber and an excited light transmitted from the optic synthesizer, to each other, and transmits the thus multiplexed light as an amplified signal light.

Japanese Unexamined Patent Publication No. 7-46192 (A) has suggested an optic amplifier and relay unit which detects a fault monitoring signal transmitted from a terminal station, out of a main signal light, and transmits a response signal by modulating an amplitude of the main signal light with a signal having a particular frequency and different from the fault monitoring signal. The suggested optic amplifier includes an optic fiber which directly amplifies the main signal light by means of an excitation light source, a first excitation light source which generates an excited light by which the main signal light is amplified to a certain optic output level, and supplies the thus generated excited light to the optic fiber, a second excitation light source which generates an excited light for exciting the response signal, and supplies the thus generated excited light to the fiber, and a controller which detects an optic output level of the main signal light and the fault monitoring signal in the main signal light, and controls both emission of the excited light from the first excitation light source and generation of the response signal from the second excitation light source.

However, the above-mentioned problems remain unsolved even in the above-mentioned Publications.

### SUMMARY OF THE INVENTION

In view of the above-mentioned problems in the conventional optic relay unit in a light transmission system, it is an object of the present invention to provide an optic relay unit, a terminal station, and a light transmission system all of which are capable of identifying an excitation light source in which a fault occurs.

It is also an object of the present invention to provide a method of identifying an excitation light source in which a fault occurs, in a light transmission system.

In one aspect of the present invention, there is an optic relay unit including (a) an excitation light source to which a predetermined inherent frequency is assigned, (b) an optical amplifier arranged in a transmission line through which a main signal light having a predetermined wavelength is transmitted, to receive the main signal light, the optical amplifier being excited by an excited light emitted from the excitation light source and amplifying the main signal light, and (c) a fault monitoring unit which generates a fault monitoring signal light modulated with the predetermined inherent frequency and having a wavelength different from the predetermined wavelength of the main signal light, when a fault occurs in the excitation light source, and transmits the fault monitoring signal light to the transmission line.

For instance, the excitation light source may be comprised of a plurality of excitation light-emitting diodes to which inherent frequencies different from one another are assigned, and wherein the fault monitoring unit, when a fault occurs in any one of the excitation light-emitting diodes, generates the fault monitoring signal light modulated with a frequency assigned to an excitation light-emitting diode in which the fault occurs.

For instance, the fault monitoring unit may be comprised of (a) a light source which emits the fault monitoring signal light, (b) a first circuit which, on receipt of fault data, transmits a signal having a frequency identified with the fault data, (c) a second circuit which, on receipt of a control signal, starts driving the light source, and modulates an intensity of the fault monitoring signal light emitted from the light source, with the frequency of the signal transmitted from the first circuit, and (d) a third circuit which, when a fault occurs in any one of the excitation light-emitting diodes, transmits the fault data to the first circuit and the control signal to the second circuit, the fault data including a frequency assigned to an excitation light-emitting diode in which the fault occurs, the control signal including an instruction to start driving the light source.

For instance, the excitation light source may be comprised of a plurality of excitation light-emitting diodes to which a common inherent frequency is assigned and each of which includes a fault monitoring unit, and wherein each of the fault monitoring units, when a fault occurs in a monitored excitation light-emitting diode, generates the fault monitoring signal light modulated with the common inherent frequency, the fault monitoring signal light having a wavelength different from wavelengths of fault monitoring lights emitted from the other fault monitoring units.

For instance, each of the fault monitoring units is comprised of (a) a light source which emits the fault monitoring signal light, (b) a first circuit which, on receipt of fault data, transmits a signal having a frequency identified with the fault data, (c) a second circuit which, on receipt of a control signal, starts driving the light source, and modulates an intensity of the fault monitoring signal light emitted from the light source, with the frequency of the signal transmitted from the first circuit, and (d) a third circuit which, when a fault occurs in the monitored excitation light-emitting diodes, transmits the fault data to the first circuit and the control signal to the second circuit, the fault data including a frequency assigned to the monitored excitation light-emitting diode in which the fault occurs, the control signal including an instruction to start driving the light source.

When the transmission line is comprised of an upward transmission line and a downward transmission line, it is preferable that the fault monitoring unit transmits the fault monitoring signal light to both of the upward and downward transmission lines.

There is further provided an optic relay unit including (a) an excitation light source, (b) an optical amplifier arranged in a transmission line through which a main signal light having a predetermined wavelength is transmitted, to receive the main signal light, the optical amplifier being excited by an excited light emitted from the excitation light source and amplifying the main signal light, and (c) a fault monitoring unit which generates a fault monitoring signal light having an wavelength in advance assigned thereto, different from the predetermined wavelength of the main signal light, when a fault occurs in the excitation light source, and transmits the fault monitoring signal light to the transmission line.

For instance, the excitation light source may be comprised of a plurality of excitation light-emitting diodes each of which includes a fault monitoring unit, and wherein each of the fault monitoring units, when a fault occurs in a monitored excitation light-emitting diode, generates the fault monitoring signal light having the assigned wavelength which is different from wavelengths of fault monitoring lights emitted from the other fault monitoring units.

For instance, each of the fault monitoring units may be comprised of (a) a light source emitting a fault monitoring light having a wavelength in advance assigned thereto and inherent thereto, (b) a first circuit which, on receipt of a control signal, starts driving the light source, and (c) a second circuit which transmits a signal including an instruction to start driving the light source, to the first circuit as the control signal, when a fault occurs in a monitored excitation light-emitting diode, wherein the light sources in the fault monitoring units emit lights having wavelengths different from one another.

In another aspect of the present invention, there is provided a terminal station receiving a signal light through a transmission line in which at least one optic relay unit is arranged, the optic relay unit being comprised of (a) an excitation light source to which a predetermined inherent frequency is assigned, (b) an optical amplifier arranged in a transmission line through which a main signal light having a predetermined wavelength is transmitted, to receive the main signal light, the optical amplifier being excited by an excited light emitted from the excitation light source and amplifying the main signal light, and (c) a fault monitoring unit which generates a fault monitoring signal light modulated with the predetermined inherent frequency and having a wavelength different from the predetermined wavelength of the main signal light, when a fault occurs in the excitation light source, and transmits the fault monitoring signal light to the transmission line, the terminal station including (a) a spectrum detector which detects spectrum of a received signal light, and (b) a fault identifier which checks whether a wavelength of a fault monitoring signal light transmitted from the optic relay unit is included in the spectrum detected by the spectrum detector, and which, if the wavelength is included in the spectrum, identifies an excitation light source in which a fault occurs, based on the wavelength and a frequency of the fault monitoring signal light.

There is further provided a terminal station receiving a signal light through a transmission line in which at least one optic relay unit is arranged, the optic relay unit being comprised of (a) an excitation light source to which a predetermined inherent frequency is assigned, (b) an optical amplifier arranged in a transmission line through which a main signal light having a predetermined wavelength is transmitted, to receive the main signal light, the optical amplifier being excited by an excited light emitted from the excitation light source and amplifying the main signal light, and (c) a fault monitoring unit which generates a fault monitoring signal light modulated with the predetermined inherent frequency and having a wavelength different from the predetermined wavelength of the main signal light, when a fault occurs in the excitation light source, and transmits the fault monitoring signal light to the transmission line, the terminal station including (a) a spectrum detector which detects spectrum of a received signal light, and (b) a fault identifier which checks whether a wavelength of a fault monitoring signal light transmitted from the optic relay unit is included in the spectrum detected by the spectrum detector, and which, if the wavelength is included in the spectrum, identifies an excitation light source in which a fault occurs, based on the wavelength of the fault monitoring signal light.

In still another aspect of the present invention, there is provided a light transmission system including (a) a plurality of optic relay units each of which includes an excitation light source to which a frequency different from frequencies assigned to other excitation light sources is assigned, and which transmits a fault monitoring signal light having a frequency modulated with a frequency assigned to an excitation light source in which a fault occurs, and (b) a terminal station which receives a signal light through the optic relay units, detects spectrum of the thus received signal light, checks whether a wavelength of the fault monitoring signal light transmitted from the optic relay unit is included in the thus detected spectrum, and, if the wavelength is included in the spectrum, identifies an excitation light source in which a fault occurs, based on the frequency of the fault monitoring signal light.

There is further provided a light transmission system including (a) a plurality of optic relay units each of which includes an excitation light source which transmits a fault monitoring signal light having a wavelength inherent thereto, if a fault occurs in the excitation light source, and (b) a terminal station which receives a signal light through the optic relay units, detects spectrum of the thus received signal light, checks whether a wavelength of the fault monitoring signal light transmitted from the optic relay unit is included in the thus detected spectrum, and, if the wavelength is included in the spectrum, identifies an excitation light source in which a fault occurs, based on the wavelength of the fault monitoring signal light.

In yet another aspect of the present invention, there is provided a method of identifying an excitation light source in which a fault occurs, in a light transmission system including a transmission line in which a plurality of optic relay units each including an excitation light source is arranged, the method including the steps of (a) assigning a frequency to each of the excitation light sources of the optic relay units such that the thus assigned frequencies are different from one another, (b) transmitting a fault monitoring signal light to the transmission line which fault monitoring signal light has a frequency modulated with a frequency assigned to an excitation light source in which a fault occurs, (c) detecting spectrum of a signal light received through the transmission line, and (d) checking whether a wavelength of the fault monitoring signal light is included in the spectrum detected in the step (c), and, if the wavelength is included in the spectrum, identifying an excitation light source in which a fault occurs, based on the frequency of the fault monitoring signal light.

There is further provided a method of identifying an excitation light source in which a fault occurs, in a light transmission system including a transmission line in which a plurality of optic relay units each including an excitation light source is arranged, the method including the steps of (a) transmitting a fault monitoring signal light to the transmission line which fault monitoring signal light has a wavelength if a fault occurs in an excitation light source, the wavelength being inherent to the excitation light source, (b) detecting spectrum of a signal light received through the transmission line, and (c) checking whether a wavelength of the fault monitoring signal light is included in the spectrum detected in the step (b), and, if the wavelength is included in the spectrum, identifying an excitation light source in which a fault occurs, based on the wavelength of the fault monitoring signal light.

The advantages obtained by the aforementioned present invention will be described hereinbelow.

In accordance with the present invention, it is possible to readily identify an excitation light source in which a fault occurs, by checking a modulated frequency and/or a wavelength of a fault monitoring signal light.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional optic relay unit.

FIG. 2 is a block diagram of an optic relay unit in accordance with the first embodiment of the present invention.

FIGS. 3A and 3B are examples of spectrum of a signal light reaching a terminal station through the optic relay unit illustrated in FIG. 1.

FIG. 4 is a block diagram of an optic relay unit in accordance with the second embodiment of the present invention.

FIG. 5 is a block diagram of an optic relay unit in accordance with the third embodiment of the present invention.

FIGS. 6A to 6C are examples of spectrum of a signal light reaching a terminal station through the optic relay unit illustrated in FIG. 4.

FIG. 7 is a block diagram of an optic relay unit in accordance with the fourth embodiment of the present invention.

FIGS. 8A to 8D are examples of spectrum of a signal light reaching a terminal station through the optic relay unit illustrated in FIG. 7.

FIG. 9 is a block diagram of an optic relay unit in accordance with the fifth embodiment of the present invention.

FIG. 10 is a block diagram of a light transmission system including the optic relay unit in accordance with the present invention.

FIG. 11 illustrates an example of assignment of a frequency to an excitation light source.

FIG. 12 is a block diagram illustrating an example of a terminal station constituting a part of the light transmission system illustrated in FIG. 10.

FIG. 13 illustrates an example of assignment of a frequency to an excitation light source in the case that excitation light sources in the optic relay units emit excited lights having wavelengths different from one another.

FIGS. 14A and 14B are examples of spectrum of a signal light reaching a terminal station through the optic relay unit illustrated in FIG. 13.

FIG. 15 is an example of spectrum of a signal light reaching a terminal station through the optic relay unit illustrated in FIG. 13.

FIG. 16 illustrates another example of assignment of a frequency to an excitation light source in the case that excitation light sources in the optic relay units emit excited lights having wavelengths different from one another.

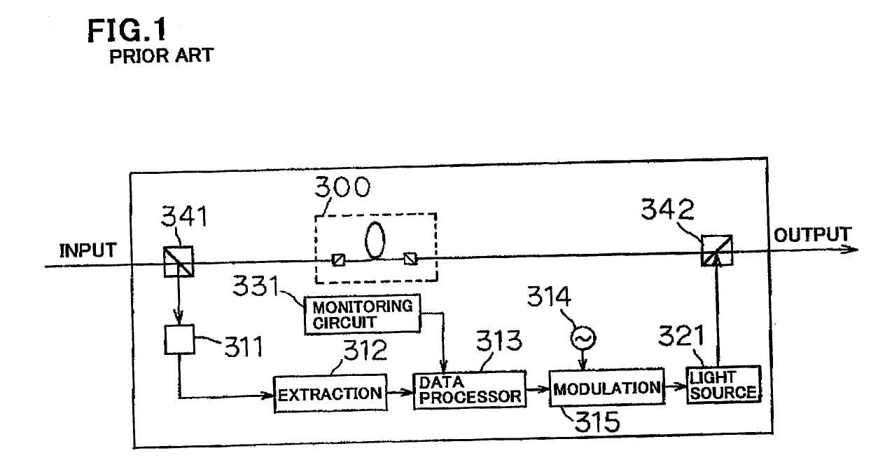

### DESCRIPTION OF THE PREFERRED EMBODIMENTS

Preferred embodiments in accordance with the present invention will be explained hereinbelow with reference to drawings.

### FIRST EMBODIMENT

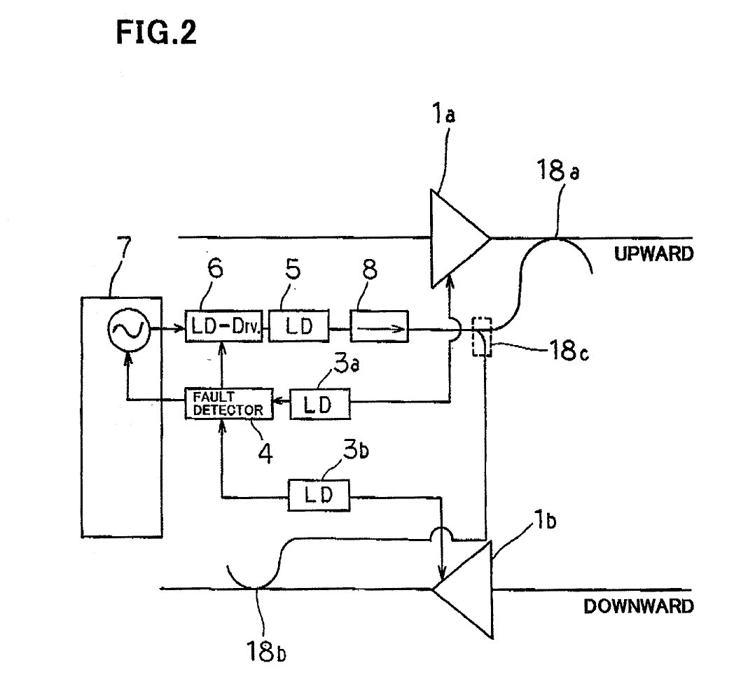

FIG. 2 is a block diagram of an optic relay unit in accordance with the first embodiment of the present invention.

The illustrated optic relay unit is comprised of a first optic amplifier 1a arranged in an upward transmission line, a first laser diode 3a acting as an excitation light source emitting an excited light for exciting the first optic amplifier 1a, a second optic amplifier 2a, a second laser diode 3b acting as an excitation light source emitting an excited light for exciting the second optic amplifier 1b, a fault detecting circuit 4, a third laser diode 5, a laser diode driver circuit 6 for driving the third laser diode 5, a signal generating circuit 7, an optic isolator 8, and first to third optic couplers 18a, 18b and 18c. The fault detecting circuit 4, the third laser diode 5, the driver circuit 6 for driving the third laser diode 5, the signal generating circuit 7, the optic isolator 8, and the first to third optic couplers 18a, 18b and 18c define a fault monitoring unit.

The fault detecting circuit 4 detects a fault which occurs in the first and second laser diodes 3a and 3b. If a fault occurs in the first and/or second laser diodes 3a and/or 3b, the fault detecting circuit 4 generates a fault detecting signal in accordance with in which the first and/or second laser diodes 3a and/or 3b a fault occurs, and transmits the thus generated fault detecting signal to the signal generating circuit 7, and further transmits a control signal to the laser diode driver circuit 6 for causing the laser diode driver circuit 6 to start driving the third laser diode 5.

The first laser diode 3a is designed to emit an excitation light having a predetermined frequency inherent to the first laser diode 3a, and similarly, the second laser diode 3b is designed to emit an excitation light having a predetermined frequency inherent to the second laser diode 3b, in order to make it possible to identify a laser diode in which a fault occurs. The fault detecting signal transmitted from the fault detecting circuit 4 includes data indicative of a frequency assigned to and inherent to the first or second diode 3a or 3b in which a fault occurs.

On receipt of the fault detecting signal from the fault detecting circuit 4, the signal generating circuit 7 generates a signal having a frequency included in the received fault detecting signal, that is, a frequency assigned to and inherent to the first or second laser diode 3a or 3b in which a fault occurred. The signal having such a frequency is transmitted to the laser diode driving circuit 6.

The laser diode driver circuit 6 drives the third laser diode 5 which emits a light with which data indicating a laser diode in which a fault occurs is transmitted. On receipt of the control signal from the fault detecting circuit 4, the laser diode driver circuit 6 starts driving the third laser diode 5, and on receipt of the signal from the signal generating circuit 7, the laser diode driver circuit 6 modulates an intensity of a light emitted from the third laser diode 5, with a frequency indicated in the signal transmitted from the signal generating circuit 7. As a result) the third laser diode 5 transmits a fault monitoring signal light modulated with a frequency assigned to and inherent to the first or second laser diode 3a or 3b in which a fault occurred.

The fault monitoring signal light transmitted from the third laser diode 5 passes through the optic isolator 8, and is separated into two parts at the third optic coupler 18c. One of the parts is merged at the first optic coupler 18a with a main signal light transmitted through the upward transmission line, and the other is merged at the second optic coupler 18b with a main signal light transmitted through the downward transmission line.

In the first embodiment, the third laser diode 5 is designed to emit a light having a wavelength out of a wavelength band of the main signal light transmitted through the upward and downward transmission lines. Hence, the fault monitoring signal light transmitted from the third laser diode 5 has a wavelength different from a wavelength of the main signal light.

The optic relay unit in accordance with the first embodiment operates as follows.

A main signal light transmitted from an upstream optic relay unit or terminal station to the upward transmission line is received in the first optic amplifier la in the optic relay unit. The first optic amplifier 1a amplifies the received main signal light by virtue of an excited light emitted from the first laser diode 3a. The thus amplified main signal light is transmitted to a downstream optic relay unit or terminal station.

Similarly to the above-mentioned operation, a main signal light transmitted from an upstream optic relay unit or terminal station to the downward transmission line is received in the second optic amplifier 1b in the optic relay unit. The second optic amplifier 1b amplifies the received main signal light by virtue of an excited light emitted from the second laser diode 3b. The thus amplified main signal light is transmitted to a downstream optic relay unit or terminal station.

If a fault occurs in the first laser diode 3a which emits an excited light to the first optic amplifier 1a, the fault detecting circuit 4 detects the fault. On detection of the fault which occurred in the first laser diode 3a, the fault detecting circuit 4 generates a fault detecting signal including data indicative of a frequency assigned to and inherent to the first laser diode 3a, and transmits the fault detecting signal to the signal generating circuit 7, and further transmits a control signal to the laser diode driver circuit 6 to start driving the third laser diode 5.

On receipt of the fault detecting signal from the fault detecting circuit 4, the signal generating circuit 7 generates a signal having a frequency assigned to and inherent to the first laser diode 3a in which a fault occurred, based on the fault detecting signal. The signal having such a frequency is transmitted to the laser diode driving circuit 6.

On receipt of the control signal from the fault detecting circuit 4, the laser diode driver circuit 6 starts driving the third laser diode 5, and on receipt of 4, the signal generating circuit 7 generates a signal having a frequency assigned to and inherent to the first laser diode 3a in which a fault occurred, based on the fault detecting signal. The signal having such a frequency is transmitted to the laser diode driving circuit 6.

On receipt of the control signal from the fault detecting circuit 4, the laser diode driver circuit 6 starts driving the third laser diode 5, and on receipt of the signal from the signal generating circuit 7, the laser diode driver circuit 6 modulates an intensity of a light emitted from the third laser diode 5, with a frequency indicated in the signal transmitted from the signal generating circuit 7.

As a result, the third laser diode 5 transmits a fault monitoring signal light modulated with a frequency assigned to and inherent to the first laser diode 3a in which a fault occurred. The fault monitoring signal light transmitted from the third laser diode 5 passes through the optic isolator 8, and then, is separated into two parts at the third optic coupler 18c. One of the parts is merged at the first optic coupler 18a with a main signal light transmitted through the upward transmission line, and the other is merged at the second optic coupler 18b with a main signal light transmitted through the downward transmission line. Thus, both of the parts are transmitted to a downstream optic relay unit or terminal station.

The main signal light including the fault monitoring signal light transmitted from the third laser diode 5 is amplified and relayed in downstream optic relay units, and finally, reaches a terminal station.

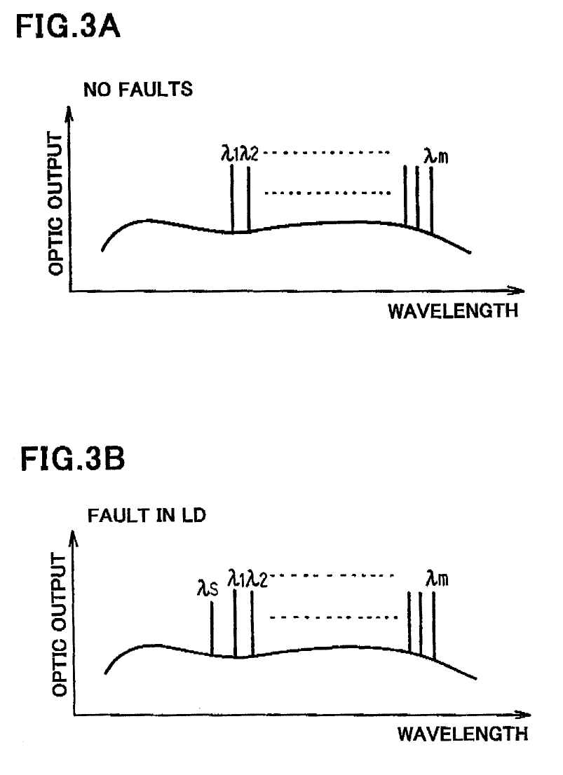

FIG. 3A illustrates an example of spectrum of a signal light reaching a terminal station on the assumption that no faults occur in an excitation light source, and FIG. 3B illustrates an example of spectrum of a signal light reaching a terminal station on the assumption that a fault occurs in an excitation light source. In FIGS. 3A and 3B, a main signal light is assumed to have a wavelength band of λ1 to λm, and an excited light emitted from the third laser diode 5 is assumed to have a wavelength λs out of the wavelength band of the main signal light.

If no faults occur in both the first and second laser diodes 3a and 3b, a terminal station would receive only the main signal light. Hence, the spectrum of the received signal light includes only a wavelength band λ1 to λm of the main signal light, as illustrated in FIG. 3A.

On the other hand, if a fault occurs in the first and/or second laser diodes 3a and/or 3b, a terminal station would receive the main signal light including the fault monitoring signal light transmitted from the third laser diode 5. Hence, the spectrum of the received signal light includes not only a wavelength band λ1 to λm of the main signal light, but also a wavelength λs of the fault monitoring signal light transmitted from the third laser diode 5.

Accordingly, it is possible to judge whether a fault occurs in an excitation light source, by monitoring whether the wavelength λs of the fault monitoring signal light transmitted from the third laser diode 5 is included in the spectrum of the received signal light.

In addition, it is also possible to identify an optic relay unit including the first or second laser diode 3a or 3b in which a fault occurred, by separating the fault monitoring signal light having a wavelength λs out of the received signal light, and detecting a frequency of the separated fault monitoring signal light.

A structure of the optic relay unit in accordance with the first embodiment is not to be limited to the above-mentioned one. The optic relay unit in accordance with the first embodiment may be designed to have any structure, if it can transmit a signal light having been modulated with a frequency assigned to and inherent to a laser diode in which a fault occurred, to an upward and/or downward transmission line.

### SECOND EMBODIMENT

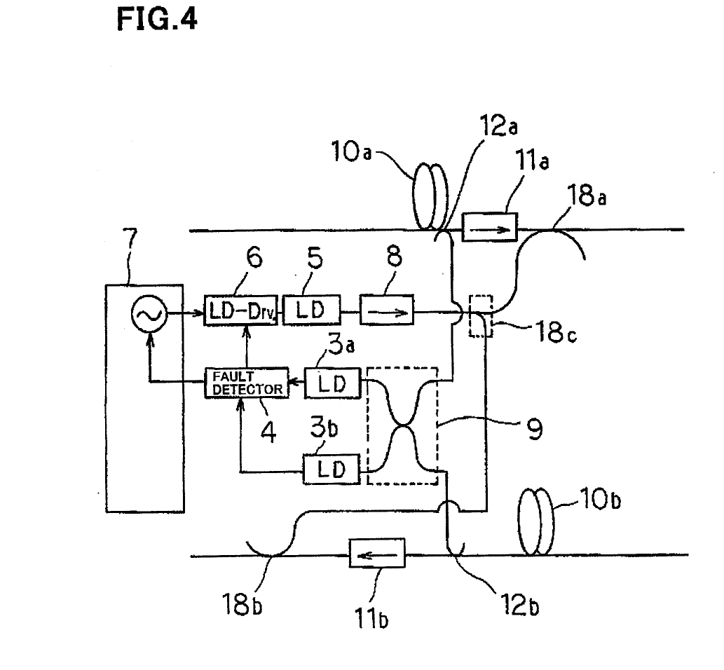

FIG. 4 is a block diagram of an optic relay unit in accordance with the second embodiment of the present invention. In the second embodiment, the optic amplifiers are designed to amplify a main signal light by means of an Erbium-doped fiber.

The optic relay unit in accordance with the second embodiment is structurally different from the optic relay unit in accordance with the first embodiment only in that the first optic amplifier 1a is comprised of a first Erbium-doped fiber 10a, a first optic isolator 11a and a first optic coupler 12a, that the second optic amplifier 1b is comprised of a second Erbium-doped fiber 10b, a second optic isolator 11b and a second optic coupler 12b, and that a 3-dB coupler 9 having four terminals is optically connected between output terminals of the first and second optic laser diodes 3a and 3b and input terminals of the first and second Erbium-doped fibers 10a and 10b.

The first Erbium-doped fiber 10a receives at one of its terminals a signal light transmitted from an upstream optic relay unit or terminal station to the upward transmission line, and further receives, at the other terminal an excited light through the first optic coupler 12a. A signal light is amplified while passing through the first Erbium-doped fiber 10a excited by the received excited light. The thus amplified signal light is output through the other terminal of the first Erbium-doped fiber 10a, and transmitted to a downstream optic relay unit or terminal station through the first optic isolator 11a.

The second Erbium-doped fiber 10b receives at one of its terminals a signal light transmitted from an upstream optic relay unit or terminal station to the downward transmission line, and further receives at the other terminal an excited light through the second optic coupler 12b. A signal light is amplified while passing through the second Erbium-doped fiber 10b excited by the received excited light. The thus amplified signal light is output through the other terminal of the second Erbium-doped fiber 10b, and transmitted to a downstream optic relay unit or terminal station through the second optic isolator 11b.

The 3-dB coupler 9 receives at one of its input terminals an excited light emitted from the first laser diode 3a, and further receives at the other input terminal an excited light emitted from the second laser diode 3b. The 3-dB coupler 9 synthesizes those excited lights to each other, and outputs the synthesized excited light through its output terminal. The synthesized excited light output through one of the output terminals of the 3-dB coupler 9 is transmitted to the first Erbium-doped fiber 10a at the other terminal thereof through the first optic coupler 12a, and the synthesized excited light output through the other output terminal of the 3-dB coupler 9 is transmitted to the second Erbium-doped fiber 10b at the other terminal thereof through the second optic coupler 12b.

In the optic relay unit in accordance with the second embodiment, if a fault occurs in the first or second laser diode 3a or 3b, the fault detecting circuit 4 detects the fault. On detection of the fault which occurred in the first or second laser diode 3a or 3b, the fault detecting circuit 4 generates a fault detecting signal including data indicative of a frequency assigned to and inherent to the first or second laser diode 3a and 3b, and transmits the fault detecting signal to the signal generating circuit 7, and further transmits a control signal to the laser diode driver circuit 6 to start driving the third laser diode 5.

On receipt of the fault detecting signal from the fault detecting circuit 4, the signal generating circuit 7 generates a signal having a frequency assigned to and inherent to the first or second laser diode 3a or 3b in which a fault occurred, based on the fault detecting signal. The signal having such a frequency is transmitted to the laser diode driving circuit 6.

On receipt of the control signal from the fault detecting circuit 4, the laser diode driver circuit 6 starts driving the third laser diode 5, and on receipt of the signal from the signal generating circuit 7, the laser diode driver circuit 6 modulates an intensity of a light emitted from the third laser diode 5, with a frequency indicated in the signal transmitted from the signal generating circuit 7.

As a result, the third laser diode 5 transmits a fault monitoring signal light modulated with a frequency assigned to and inherent to the first or second laser diode 3a or 3b in which a fault occurred. The fault monitoring signal light transmitted from the third laser diode 5 passes through the optic isolator 8, and then, is separated into two parts at the third optic coupler 18c. One of the parts is merged at the first optic coupler 18a with a main signal light transmitted through the upward transmission line, and the other is merged at the second optic coupler 18b with a main signal light transmitted through the downward transmission line. Thus, both of the parts are transmitted to a downstream optic relay unit or terminal station.

### THIRD EMBODIMENT

Though the optic relay units in accordance with the above-mentioned first and second embodiments are designed to include a single fault monitoring unit, they may be designed to include a fault monitoring unit in association with each of excitation light sources. The optic relay unit in accordance with the third embodiment explained hereinbelow is designed to include a fault monitoring unit for each of excitation light sources.

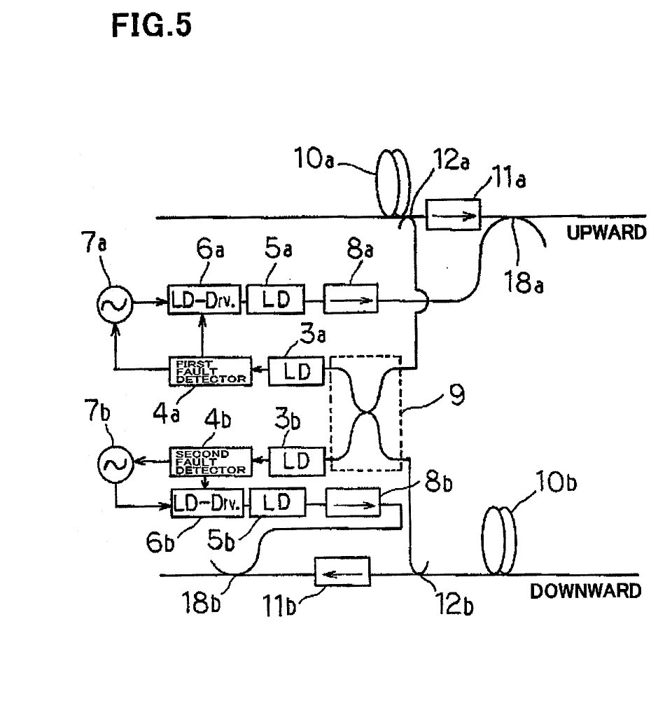

FIG. 5 is a block diagram of an optic relay unit in accordance with the third embodiment of the present invention.

The optic relay unit in accordance with the third embodiment is structurally different from the optic relay unit in accordance with the second embodiment in that a fault monitoring unit is arranged not only for the first laser diode 3a, but also for the second laser diode 3b.

The fault monitoring unit for the first laser diode 3a is defined by a first fault detecting circuit 4a, a third laser diode 5a, a first laser diode driver circuit 6a, a first signal generating circuit 7a, a first optic isolator 8a, and a first optic coupler 18a.

If a fault occurs in the first laser diode 3a, the first fault detecting circuit 4a detects the fault. On receipt of a control signal from the first fault detecting circuit 4a, the first laser diode driving circuit 6a starts driving the third laser diode 5a, and then, on receipt of a signal having a frequency assigned to and inherent to the first laser diode 3a in which a fault occurred, from the first signal generating circuit 7a, the first laser diode driver circuit 6a modulates an intensity of a light emitted from the third laser diode 5a, with the frequency of the signal received from the first signal generating circuit 7a. The thus modulated signal light, that is, a fault monitoring signal light passes through the first optic isolator 8a, and then, is merged at the first optic coupler 18a with a main signal light transmitted through the upward transmission line. Then, the main signal light including the fault monitoring signal light is transmitted to a downstream optic relay unit or terminal station.

The fault monitoring unit for the second laser diode 3b is defined by a second fault detecting circuit 4b, a fourth laser diode 5b, a second laser diode driver circuit 6b, a second signal generating circuit 7b, a second optic isolator 8b, and a second optic coupler 18b.

If a fault occurs in the second laser diode 3b, the second fault detecting circuit 4b detects the fault. On receipt of a control signal from the second fault detecting circuit 4b, the second laser diode driving circuit 6b starts driving the fourth laser diode 5b, and then, on receipt of a signal having a frequency assigned to and inherent to the second laser diode 3b in which a fault occurred, from the second signal generating circuit 7b, the second laser diode driver circuit 6b modulates an intensity of a light emitted from the fourth laser diode 5b, with the frequency of the signal received from the second signal generating circuit 7b. The thus modulated signal light, that is, a fault monitoring signal light passes through the second optic isolator 8b, and then, is merged at the second optic coupler 18b with a main signal light transmitted through the downward transmission line. Then, the main signal light including the fault monitoring signal light is transmitted to a downstream optic relay unit or terminal station.

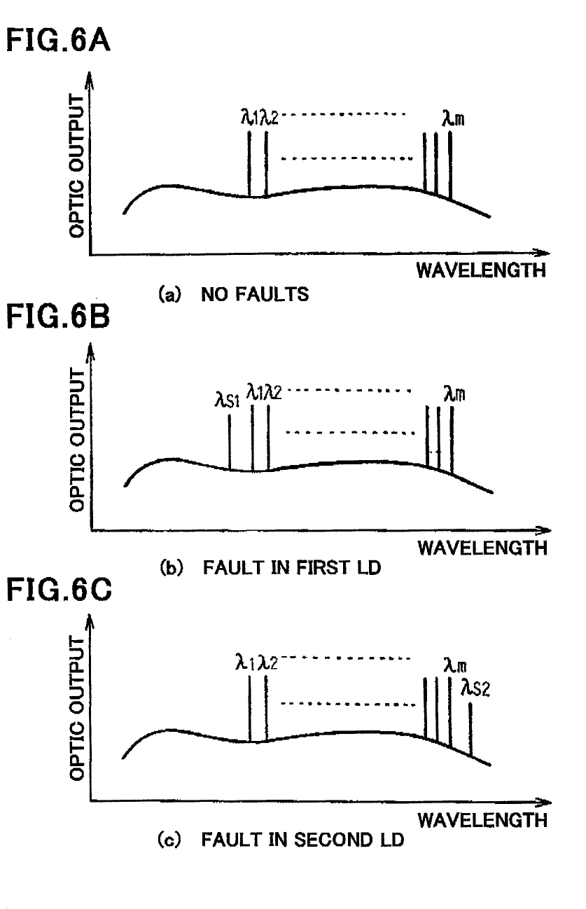

FIGS. 6A to 6C illustrate examples of spectrum of a signal light reaching a terminal station through the optic relay unit illustrated in FIG. 5. FIG. 6A illustrates an example of spectrum of a signal light reaching a terminal station on the assumption that no faults occur in both the first and second laser diodes 3a and 3b, FIG. 6B illustrates an example of spectrum of a signal light reaching a terminal station on the assumption that a fault occurs in the first laser diode 3a, and FIG. 6C illustrates an example of spectrum of a signal light reaching a terminal station on the assumption that a fault occurs in the second laser diode 3b. In FIGS. 6A to 6C, the third laser diode 5a is designed to emit a light having a wavelength of λ_{S1}, and the fourth laser diode 5b is designed to emit a light having a wavelength of λ_{S2}. Both of the wavelengths λ_{S1} and λ_{S2} are out of a wavelength band λ1 to λm of a main signal light.

If no faults occur in both the first and second laser diodes 3a and 3b, a terminal station would receive only the main signal light. Hence, the spectrum of the received signal light includes only a wavelength band λ1 to λm of the main signal light, as illustrated in FIG. 6A.

On the other hand, if a fault occurs in the first laser diode 3a, a terminal station in the upward transmission line would receive the main signal light including the fault monitoring signal light transmitted from the third laser diode 5a. Hence, the spectrum of the received signal light includes not only a wavelength band λ1 to λm of the main signal light, but also a wavelength λ_{S1} of the fault monitoring signal light transmitted from the third laser diode 5a, as illustrated in FIG. 6B.

If a fault occurs in the second laser diode 3b, a terminal station in the downward transmission line would receive the main signal light including the fault monitoring signal light transmitted from the fourth laser diode 5b. Hence, the spectrum of the received signal light includes not only a wavelength band λ1 to λm of the main signal light, but also a wavelength λ_{S2} of the fault monitoring signal light transmitted from the fourth laser diode 5b, as illustrated in FIG. 6C.

Accordingly, the terminal station in the upward transmission line can judge whether a fault occurs in the first laser diode 3a, by monitoring whether the wavelength λ_{S1} of the fault monitoring signal light transmitted from the third laser diode 5a is included in the spectrum of the received signal light.

In addition, it is also possible to identify the first laser diode 3a in which a fault occurred, among the first laser diodes 3a in a plurality of the optic relay units, by separating the fault monitoring signal light having a wavelength λ_{S1} out of the received signal light, and detecting a frequency of the separated fault monitoring signal light.

Similarly, the terminal station in the downward transmission line can judge whether a fault occurs in the second laser diode 3b, by monitoring whether the wavelength λ_{S2} of the fault monitoring signal light transmitted from the fourth laser diode 5b is included in the spectrum of the received signal light.

In addition, it is also possible to identify the second laser diode 3b in which a fault occurred, among the second laser diodes 3b in a plurality of the optic relay units, by separating the fault monitoring signal light having a wavelength λ_{S2} out of the received signal light, and detecting a frequency of the separated fault monitoring signal light.

In the optic relay unit in accordance with the third embodiment, the third and fourth laser diodes 5a and 5b may be designed to emit excited lights having wavelengths different from each other, in which case, a common frequency is assigned to the first and second laser diodes 3a and 3b, and an excitation laser diode in which a fault occurs is identified in accordance with a wavelength of a fault monitoring signal light. Accordingly, it is no longer necessary for the optic relay unit to include a signal generating circuit such as the signal generating circuit 4, 4a or 4b.

As an alternative, the third and fourth laser diodes 5a and 5b may be designed to emit excited lights having the same wavelength as each other, in which case, an excitation laser diode in which a fault occurs is identified, based on the frequency of the fault monitoring signal light.

### FOURTH EMBODIMENT

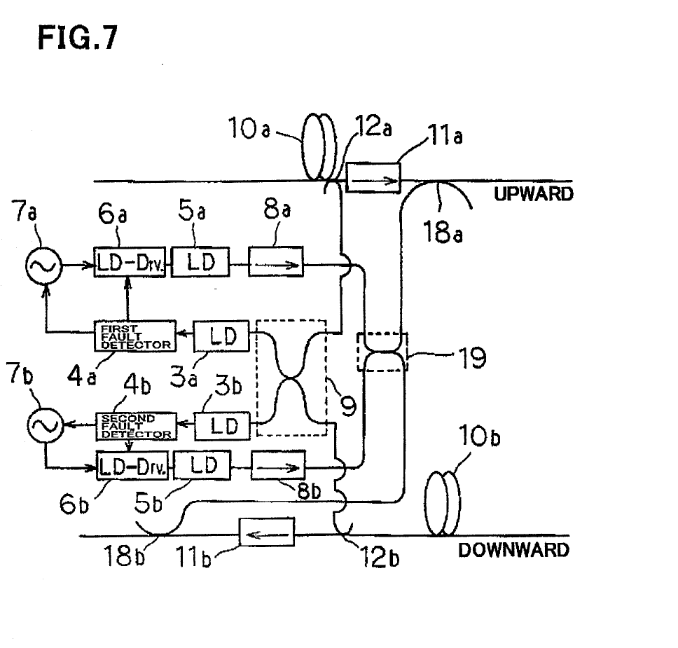

FIG. 7 is a block diagram of an optic relay unit in accordance with the fourth embodiment of the present invention.

The optic relay unit in accordance with the fourth embodiment is structurally different from the optic relay unit in accordance with the third embodiment, illustrated in FIG. 5, in that a 3-dB coupler 19 is arranged between optic output terminals of the first and second optic isolators 8a and 8b and the upward and downward transmission lines.

The 3-dB coupler 19 receives at one of its input terminals a signal light having passed through the fist optic isolator 8a, and further receives at the other input terminal a signal light having passed through the second optic isolator 8b. The former signal light is one having been modulated with a frequency assigned to and inherent to the first laser diode 3a, and transmitted from the third laser diode 5a, and the latter signal light is one having been modulated with a frequency assigned to and inherent to the second laser diode 3b, and transmitted from the fourth laser diode 5b.

On receipt of a signal light at any one of the input terminals, the 3-dB coupler 19 distributes the received signal light to the output terminals. For instance, if the 3-dB coupler 19 receives at one of the input terminals thereof a signal light transmitted from the third laser diode 5a, the received signal light is distributed to each of the output terminals of the 3-dB coupler 19. A signal light output from the 3-dB coupler 19 through one of its output terminals is merged at the first optic coupler 18a with a main signal light transmitted through the upward transmission line, and then, is transmitted to a downstream optic relay unit or terminal station. A signal light output from the 3-dB coupler 19 through the other output terminal is merged at the second optic coupler 18b with a main signal light transmitted through the downward transmission line, and then, is transmitted to a downstream optic relay unit or terminal station.

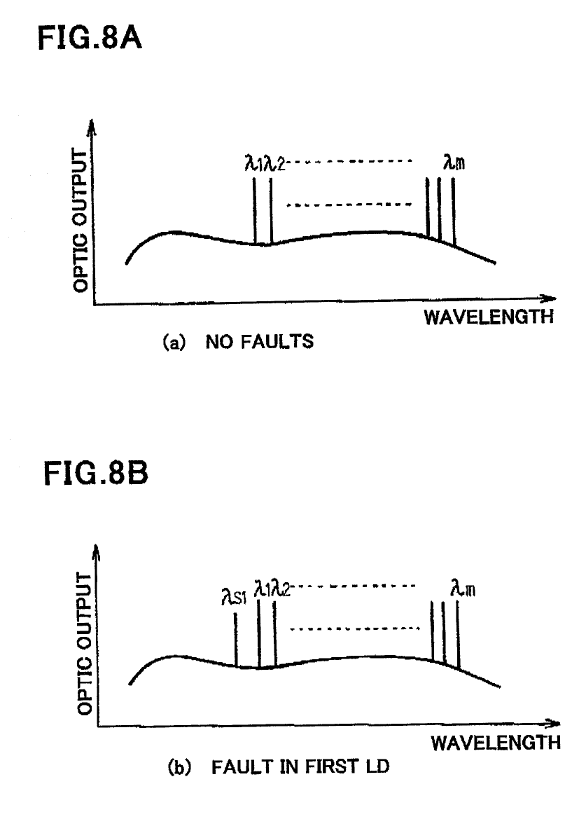

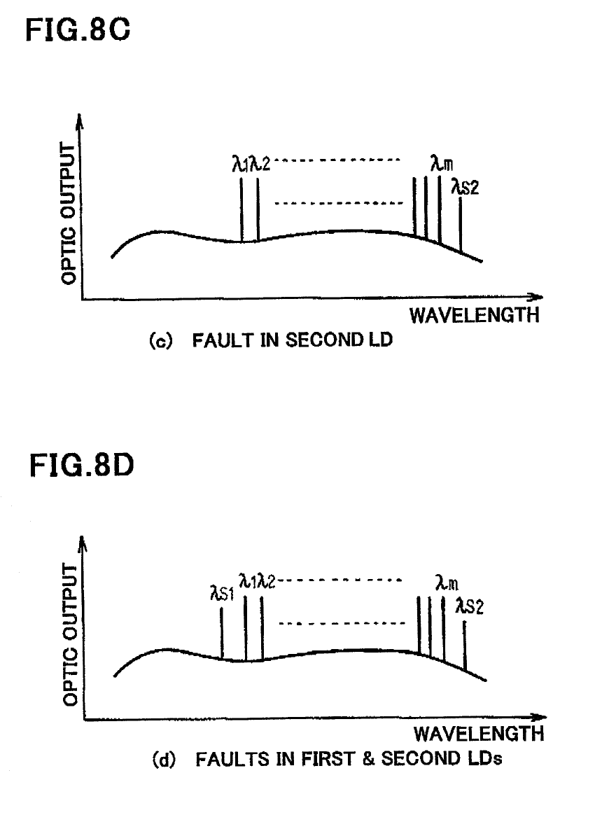

FIGS. 8A to 8D illustrate examples of spectrum of a signal light reaching a terminal station through the optic relay unit illustrated in FIG. 7. FIG. 8A illustrates an example of spectrum of a signal light reaching a terminal station on the assumption that no faults occur in both the first and second laser diodes 3a and 3b, FIG. 8B illustrates an example of spectrum of a signal light reaching a terminal station on the assumption that a fault occurs in the first laser diode 3a, FIG. 8C illustrates an example of spectrum of a signal light reaching a terminal station on the assumption that a fault occurs in the second laser diode 3b, and FIG. 8D illustrates an example of spectrum of a signal light reaching a terminal station on the assumption that a fault occurs in both the first and second laser diodes 3a and 3b. In FIGS. 8A to 8D, the third laser diode 5a is designed to emit a light having a wavelength of λ_{S1}, and the fourth laser diode 5b is designed to emit a light having a wavelength of λ_{S2}, similarly to the above-mentioned second embodiment Both of the wavelengths λ_{S1} and λ_{S2} are out of a wavelength band λ1 to λm of a main signal light.

In the fourth embodiment, the terminal stations arranged in both the upward and downward transmission lines receive a signal light having the same spectrum.

If no faults occur in both the first and second laser diodes 3a and 3b, a terminal station would receive only the main signal light. Hence, the spectrum of the received signal light includes only a wavelength band λ1 to λm of the main signal light, as illustrated in FIG. 8A.

On the other hand, if a fault occurs in the first laser diode 3a, a terminal station in the upward transmission line would receive the main signal light including the fault monitoring signal light having been modulated with a frequency assigned to and inherent to the first optic laser diode 3a and transmitted from the third laser diode 5a. Hence, the spectrum of the received signal light includes not only a wavelength band λ1 to λm of the main signal light, but also a wavelength λ_{S1} of the fault monitoring signal light transmitted from the third laser diode 5a, as illustrated in FIG. 8B.

If a fault occurs in the second laser diode 3b, a terminal station in the downward transmission line would receive the main signal light including the fault monitoring signal light having been modulated with a frequency assigned to and inherent to the second optic laser diode 3b and transmitted from the fourth laser diode 5b. Hence, the spectrum of the received signal light includes not only a wavelength band λ1 to λm of the main signal light, but also a wavelength λ_{S2} of the fault monitoring signal light transmitted from the fourth laser diode 5b, as illustrated in FIG. 8C.

If a fault occurs in both the first and second laser diodes 3a and 3b, terminal stations in the upward and downward transmission lines would receive the main signal light including both the fault monitoring signal light having been modulated with a frequency assigned to and inherent to the first optic laser diode 3a and transmitted from the third laser diode 5a, and the fault monitoring signal light having been modulated with a frequency assigned to and inherent to the second optic laser diode 3b and transmitted from the fourth laser diode 5b. Hence, the spectrum of the received signal light includes not only a wavelength band λ1 to λm of the main signal light, but also a wavelength λ_{S1} of the fault monitoring signal light transmitted from the third laser diode 5a and a wavelength λ_{S2} of the fault monitoring signal light transmitted from the fourth laser diode 5b, as illustrated in FIG. 8D.

Accordingly, the terminal stations in the upward and downward transmission lines can judge whether a fault occurs in the first and second laser diodes 3a and 3b, by monitoring whether the wavelength λ_{S1} of the fault monitoring signal light transmitted from the third laser diode 5a and the wavelength λ_{S2} of the fault monitoring signal light transmitted tom the fourth laser diode 5b are included in the spectrum of the received signal light.

In addition, it is also possible to identify the first and second laser diodes 3a and 3b in which a fault occurred, among the first and second laser diodes 3a and 3b in a plurality of the optic relay units, by separating both the fault monitoring signal light having a wavelength λ_{S1} and the fault monitoring signal light having a wavelength λ_{S2} out of the received signal light, and detecting a frequency of each of the separated fault monitoring signal lights.

### FIFTH EMBODIMENT

In the above-mentioned first embodiment, frequencies different from each other are assigned to the first and second laser diodes 3a and 3b as excitation light sources, and a laser diode in which a fault occurs is identified by modulating a fault monitoring signal light with a frequency assigned and inherent to the laser diode, and transmitting the thus modulated fault monitoring signal light onto a transmission line. In contrast, as mentioned hereinbelow in the fifth embodiment, it is possible to identify a laser diode in which a fault occurs, by arranging light sources in each of the optic relay units which light sources are designed to emit fault monitoring signal lights having wavelengths different from one another, and detecting a wavelength of a received fault monitoring signal light.

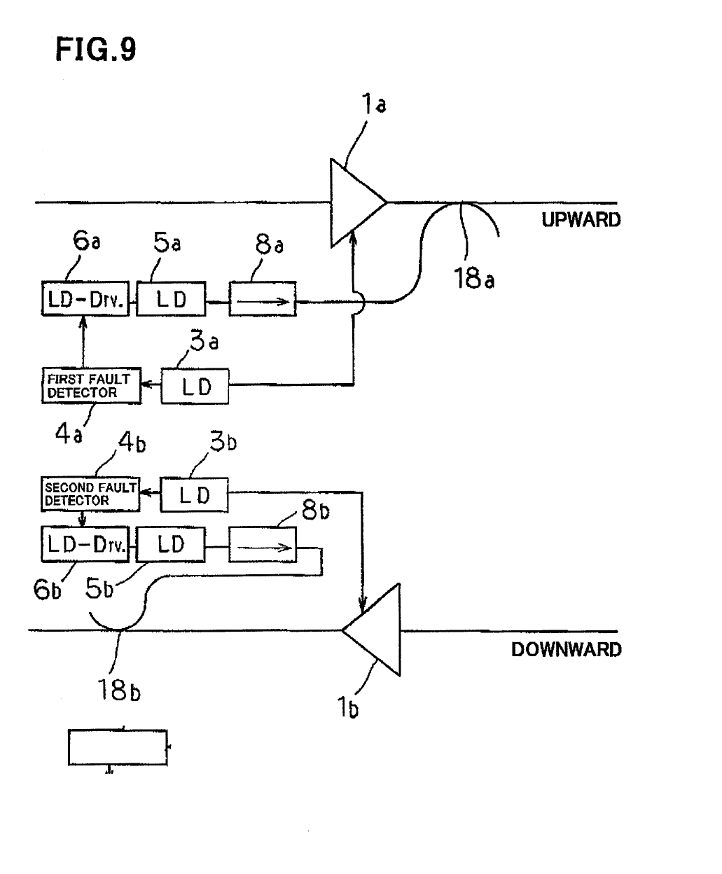

FIG. 9 is a block diagram of an optic relay unit in accordance with the fifth embodiment of the present invention.

The optic relay unit in accordance with the fifth embodiment is structurally different from the optic relay unit in accordance with the first embodiment, illustrated in FIG. 2, in that a fault monitoring unit is arranged not only for the first laser diode 3a, but also for the second laser diode 3b.

The fault monitoring unit for the first laser diode 3a is defined by a first fault detecting circuit 4a, a third laser diode 5a, a first laser diode driver circuit 6a, a first optic isolator 8a, and a first optic coupler 18a.

The fault monitoring unit for the second laser diode 3b is defined by a second fault detecting circuit 4b, a fourth laser diode 5b, a second laser diode driver circuit 6b, a second optic isolator 8b, and a second optic coupler 18b.

The third and fourth laser diodes 5a and 5b are designed to emit fault monitoring signal lights having wavelengths different from each other and inherent to the third and fourth laser diodes 5a and 5b.

If a fault occurs in the first laser diode 3a, the first fault detecting circuit 4a detects the fault. Then, the first fault detecting circuit 4a transmits a control signal to the first laser diode driver circuit 6a to start driving the third laser diode 5a. On receipt of the control signal from the first fault detecting circuit 4a, the first laser diode driving circuit 6a starts driving the third laser diode 5a. A fault monitoring signal light transmitted from the third laser diode 5a passes through the first optic isolator 8a, and then, is merged at the first optic coupler 18a with a main signal light transmitted through the upward transmission line. Then, the main signal light including the fault monitoring signal light is transmitted to a downstream optic relay unit or terminal station.

If a fault occurs in the second laser diode 3b, the second fault detecting circuit 4b detects the fault. Then, the second fault detecting circuit 4b transmits a control signal to the second laser diode driver circuit 6b to start driving the fourth laser diode 5b. On receipt of the control signal from the second fault detecting circuit 4b, the second laser diode driving circuit 6b starts driving the fourth laser diode 5b. A fault monitoring signal light transmitted from the fourth laser diode 5b passes through the second optic isolator 8b, and then, is merged at the second optic coupler 18b with a main signal light transmitted through the downward transmission line. Then, the main signal light including the fault monitoring signal light is transmitted to a downstream optic relay unit or terminal station.

In accordance with the fifth embodiment, the third and fourth laser diodes 5a and 5b are arranged for the first and second laser diodes 3a and 3b, and are designed to emit fault monitoring signal lights having wavelengths different from each other and inherent to the third and fourth laser diodes 5a and 5b. On receipt of a signal light, a terminal station checks whether a fault monitoring signal is included in the received signal light, and, if included, a terminal station can identify an excitation light source in which a fault occurred, based on a wavelength of the received fault monitoring signal light.

The optic relay unit in accordance with the fifth embodiment is not necessary to include a signal generating circuit such as the signal generating circuit 7 in the first embodiment illustrated in FIG. 2.

### SIXTH EMBODIMENT

In the above-mentioned second to fifth embodiments, the optic relay units are rear excitation type optic relay units in which an excited light is introduced into an Erbium-doped fiber at the rear thereof. The present invention is not to be limited to such a rear excitation type optic relay unit, but may be applied to a front excitation type optic relay unit in which an excited light is introduced into an Erbium-doped fiber at the front thereof. In addition, the present invention may be applied to an optic relay unit in which an excited light is introduced into an Erbium-doped fiber at both the front and rear thereof. As an example of such an optic relay unit, hereinbelow is explained an optic relay unit in which an excited light is introduced into an Erbium-doped fiber at both the front and rear thereof.

When a signal light is to be amplified by means of an Erbium-doped fiber, it would be possible to efficiently amplify a signal light without generation of noises, by introducing an excited light into an Erbium-doped fiber through opposite ends thereof In a first example, an excited light emitted from an excitation light source is separated into two parts, and the two parts of an excited light are introduced into an Erbium-doped fiber through opposite ends thereof. In a second example, two excited lights emitted from two excitation light sources are introduced into an Erbium-doped fiber through opposite ends thereof.

The above-mentioned first example may be accomplished by arranging the optic relay unit in accordance with the second embodiment, illustrated in FIG. 4, as follows.

A first 3-dB coupler is connected to one of output terminals of the 3-dB coupler 9, and a second 3-dB coupler is connected to the other output terminal of the 3-dB coupler 9. The excited light emitted from the first laser diode 3a is distributed by the first 3-dB coupler, and the thus distributed excited lights are input into the first Erbium-doped fiber 10a through opposite ends thereof. The excited light emitted from the second laser diode 3b is distributed by the second 3-dB coupler, and the thus distributed excited lights are input into the second Erbium-doped fiber 10b through opposite ends thereof. Thus, the above-mentioned first example is accomplished.

The above-mentioned second example may be accomplished by arranging the optic relay unit in accordance with the second embodiment, illustrated in FIG. 4, as follows.

In the second embodiment, the first and second laser diodes 3a and 3b, the 3-dB coupler 9, and the first and second optic couplers 12a and 12b define a first exciter which introduces an excited light into the first and second Erbium-doped fibers 10a and 10b at the rear thereof. The optic relay unit in accordance with the second embodiment is designed to additionally include a second exciter having the same structure as the structure of the first exciter. The second exciter introduces an excited light into the first and second Erbium-doped fibers 10a and 10b at the front thereof. Thus, the above-mentioned second example is accomplished.

The second example has four excitation light sources o which frequencies different from one another are assigned. If a fault occurs in any one of excitation laser diodes, the fault detecting circuit 4 transmits a control signal to the laser diode driver circuit 6 for starting driving the laser diode 5, and further transmits a signal to the signal generating circuit 7 which signal includes data indicative of a frequency assigned to and inherent to a laser diode in which a fault occurred. The laser diode driver circuit 6 and the signal generating circuit 7 operate in the same way as mentioned earlier.

### SEVENTH EMBODIMENT

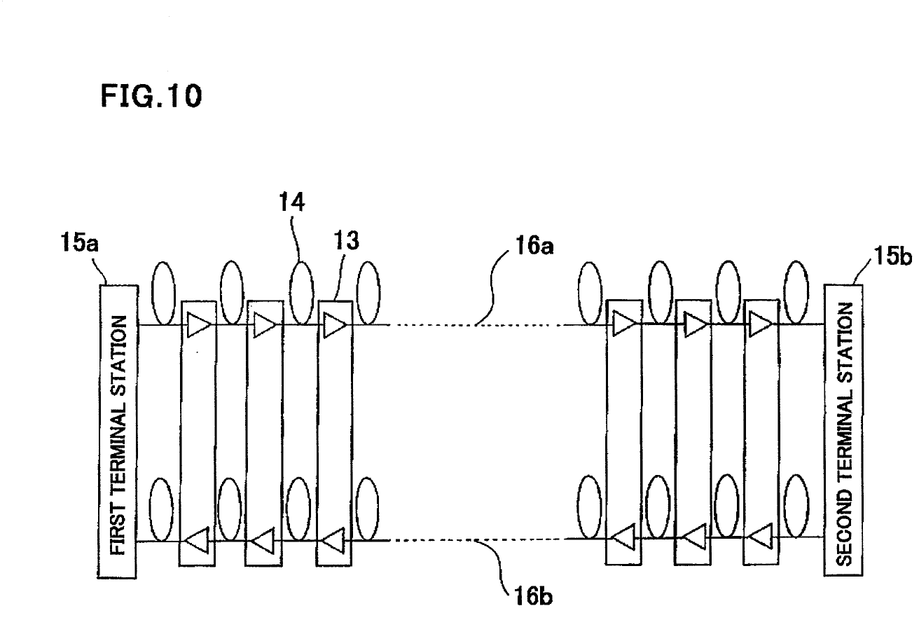

FIG. 10 is a block diagram of a light transmission system in accordance with the seventh embodiment of the present invention.

As illustrated in FIG. 10, the light transmission system a first terminal station 15a, a second terminal station 15b, an upward transmission line 16a comprised of a plurality of optic fiber transmission lines 14 and connecting the first and second terminal stations 15a and 15b to each other, a downward transmission line 16b comprised of a plurality of optic fiber transmission lines 14 and connecting the first and second terminal stations 15a and 15b to each other, and a plurality of optic relay units 13 arranged between the optic fiber transmission lines 14.

Each of the optic relay units 13 is comprised of the optic relay unit in accordance with the first embodiment, illustrated in FIG. 2. Laser diodes in the optic relay units 13 for transmitting a fault monitoring signal light, corresponding to the third laser diode 5 in FIG. 2, are designed to emit fault monitoring signal lights having a common wavelength λs. An excitation laser diode arranged for the upward transmission line 16a in each of the optic relay units 13, corresponding to the first laser diode 3a in FIG. 2, and an excitation laser diode arranged for the downward transmission line 16b in each of the optic relay units 13, corresponding to the second laser diode 3b in FIG. 2, are designed to emit excited lights having frequencies different from each other in order to make it possible to identify an excitation laser diode in which a fault occurred, based on a frequency of a received fault monitoring signal light.

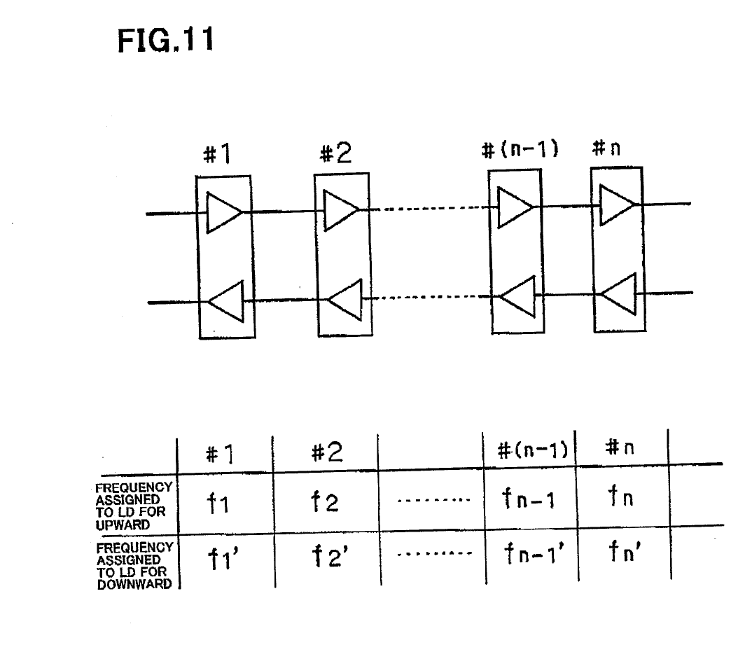

FIG. 11 shows an example of assignment of a frequency to excitation laser diodes.

In the example, the optic relay units 13 are assigned numbers #1, #2, - - - , #(n-1), and #n in an order from the first terminal station 15a, and further assigned both frequencies of an excitation laser diode arranged for the upward transmission line 16a, f1, f2, - - - , f(n-1), and fn and frequencies of an excitation laser diode arranged for the downward transmission line 16b, f1′, f2′, - - - , f(n-1)′, and fn′. For instance, a frequency f1 is assigned to an excitation laser diode numbered #1 and arranged for the upward transmission line 16a, and a frequency f1′ is assigned to an excitation laser diode numbered #1 and arranged for the downward transmission line 16b.

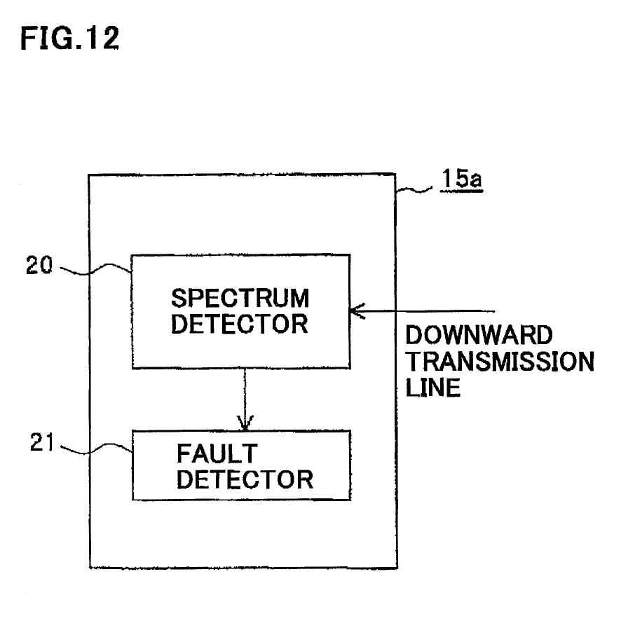

FIG. 12 is a block diagram illustrating an example of a structure of the first terminal station 15a.

The first terminal station 15a is comprised of a spectrum detector 20 which detects spectrum of a signal light received through the downward transmission line 16b, and a fault detector 21 which inspects whether a fault monitoring signal light emitted fiom the third laser diode 5 and having a wavelength of λs is included in the spectrum detected by the spectrum detector 20, and judges that a fault occurs in an excitation laser diode, if a fault monitoring signal light having a wavelength of λs is included in the detected spectrum.

If a fault monitoring signal light having a wavelength of λs is included in the detected spectrum, the fault detector 21 identifies an optic relay unit including an excitation laser diode in which a fault occurred, based on the modulated frequency of the fault monitoring signal light having a wavelength of λs.

The second terminal station 15b has the same structure as the structure of the first terminal station 15a except that the second terminal station 15b judges whether a fault occurs in an excitation laser diode, based on spectrum of a signal light received through the upward transmission line 16a.

Hereinbelow is explained an operation of the light transmission system for identifying an excitation laser diode in which a fault occurred.

When an excitation laser diode in each of the optic relay units 13 operates normally, for instance, a main signal light transmitted from the first terminal station 15a to the upward transmission line 16a is amplified and relayed in each of the optic relay units 13, and then, received in the second terminal station 15b. The spectrum detector 20 in the second terminal station 15b detects spectrum in the received main signal light, and then, the fault detector 21 inspects whether a fault monitoring signal light having a wavelength of λs is included in the detected spectrum. When an excitation laser diode in each of the optic relay units 13 operates normally, a fault monitoring signal light having a wavelength of λs is not included in the detected spectrum. Hence, the fault detector 21 judges that no faults occur in an excitation laser diode in each of the optic relay units 13. An operation carried out for the upward transmission line 16a is also carried out for the downward transmission line 16b.

It is now assumed that a fault occurs in an excitation laser diode in any one of the optic relay units 13. The optic relay unit 13 including an excitation laser diode in which a fault occurs transmits a fault monitoring signal light having a wavelength of λs, modulated with a frequency assigned to and inherent to the excitation laser diode.

Hereinbelow is explained an operation of identifying an excitation laser diode in the assumption that a fault occurs in an excitation laser diode arranged for the upward transmission line 16a in the optic relay unit numbered #2. Such an excitation laser diode corresponds to the first laser diode 3a in the first embodiment) illustrated in FIG. 2.

In the optic relay unit numbered #2, the fault detecting circuit 4 detects that a fault occurred in the first laser diode 3a. On receipt of a control signal from the first fault detecting circuit 4, the laser diode driving circuit 6 starts driving the third laser diode 5, and further, on receipt of a signal having a frequency f2 assigned to and inherent to the first laser diode 3a in which a fault occurred, from the signal generating circuit 7, the laser diode driver circuit 6 modulates an intensity of a light emitted from the third laser diode 5a, with the frequency f2. The thus modulated cult monitoring signal light passes through the optic isolator 8, and then, is separated at the third optic coupler 18c into two parts. One of the two parts is merged at the first optic coupler 18a with a main signal light transmitted through the upward transmission line, and the other part is merged at the second optic coupler 18b with a main signal light transmitted through the downward transmission line. Then, the main signal light including the fault monitoring signal light is transmitted to a downstream optic relay unit in the upward and downward transmission lines.

The main signal light to which the fault monitoring signal light having a wavelength of λs, modulated with the frequency f2 in the first optic coupler 18a, is merged is transmitted through the upward transmission line 16a, and amplified and relayed in the downstream optic relay units #3 to #n, and finally received in the second terminal station 15b. The spectrum detector 20 in the second terminal station 15b detects spectrum in the received main signal light, and then, the fault detector 21 inspects whether the fault monitoring signal light having a wavelength of λs is included in the detected spectrum. Since the spectrum includes the fault monitoring signal light having a wavelength of λs, the fault detector 21 judges that a fault occur in an excitation laser diode in any one of the optic relay units 13, and identifies an excitation laser diode, based on the modulated frequency f2 of the fault monitoring signal light having a wavelength of λs.

The main signal light to which the fault monitoring signal light having a wavelength of λs, modulated with the frequency f2 in the second optic coupler 18b, is merged is transmitted through the downward transmission line 16b, and amplified and relayed in the downstream optic relay unit #1, and finally received in the first terminal station 15a. The spectrum detector 20 in the first terminal station 15a detects spectrum in the received main signal light, and then, the fault detector 21 inspects whether the fault monitoring signal light having a wavelength of λs is included in the detected spectrum. Since the spectrum includes the fault monitoring signal light having a wavelength of λs, the fault detector 21 judges that a fault occur in an excitation laser diode in any one of the optic relay units 13, and identifies an excitation laser diode, based on the modulated frequency f2 of the fault monitoring signal light having a wavelength of λs.

In the above-mentioned light transmission system, assignment of a frequency to excitation laser diodes is not to be limited to the assignment shown in FIG. 11. In the assignment shown in FIG. 11, laser diodes for transmitting a fault monitoring signal light in each of the optic relay units, corresponding to the third laser diode 5 in FIG. 2, are assigned a common wavelength, and an excitation laser diode arranged for the upward transmission line, corresponding to the first laser diode 3a in FIG. 2, and an excitation laser diode arranged for the downward transmission line, corresponding to the second laser diode 3b in FIG. 2, are assigned frequencies different from each other. In addition, frequencies assigned to excitation laser diodes arranged for the upward and downward transmission lines in a certain optic relay unit are different from those in other optic relay units. If a laser diode in a certain optic relay unit, corresponding to the third laser diode 5 in FIG. 2, were designed to emit a fault monitoring signal light having a wavelength different from wavelengths of fault monitoring signal lights emitted from laser diodes in other optic relay units, it would be possible to assign a common frequency to excitation laser diodes arranged for the upward and downward transmission lines in all of the optic relay units.

Hereinbelow are explained examples of assignment of a frequency.

A first example of assignment is for an optic relay unit including two excitation laser diodes.

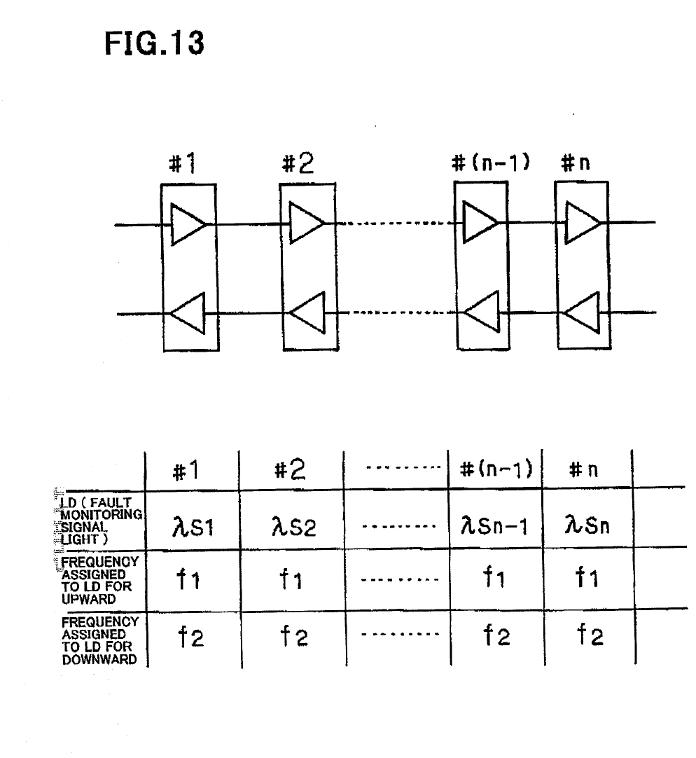

FIG. 13 shows an example of assignment of a frequency to excitation laser diodes in the case that a laser diode for transmitting a fault monitoring signal light in a certain optic relay unit is designed to emit a fault monitoring signal light having a wavelength different from wavelengths of fault monitoring signal lights emitted from laser diodes in other optic relay units. Similarly to the assignment shown in FIG. 11, the optic relay units are assigned numbers #1, #2, - - - , #(n-1), and #n. A laser diode in a certain optic relay unit is designed to emit a fault monitoring signal light having a wavelength different from wavelengths of fault monitoring signal lights emitted from laser diodes in other optic relay units. Specifically, laser diodes in the optic relay units #1 to #n are designed to emit a fault monitoring signal light having a wavelength λS1 to λSn, respectively. The wavelengths λS1 to λSn are out of a wavelength band of a main signal light. Frequencies f1 and f2 different from each other are assigned to excitation laser diodes arranged for the upward and downward transmission lines, and a common frequency is assigned to the optical relay units #1 to #n.

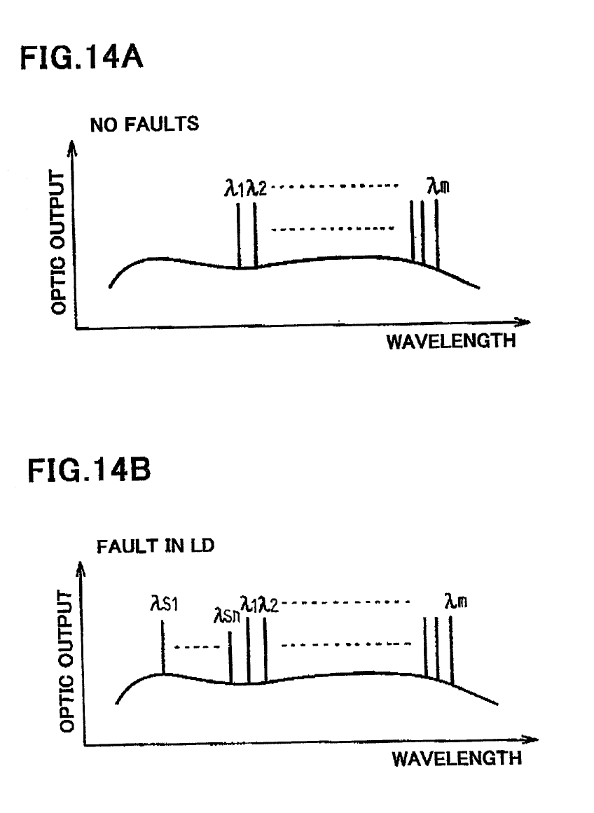

FIGS. 14A and 14B show examples of spectrum of signal lights received in terminal stations in accordance with the assignment of frequencies shown in FIG. 13. FIG. 14A illustrates an example of spectrum of a signal light reaching a terminal station on the assumption that no faults occur in an excitation light source, and FIG. 14B illustrates an example of spectrum of a signal light reaching a terminal station on the assumption that a fault occurs in an excitation light source.

If no faults occur in excitation laser diodes, a terminal station would receive only the main signal light. Hence, the spectrum of the received signal light includes only a wavelength band λ1 to λm of the main signal light, as illustrated in FIG. 14A.

On the other hand, if a fault occurs in a laser diodes in any one of the optic relay units, a terminal station would receive the main signal light including a signal light having been modulated with a frequency assigned to an excitation laser diode in which a fault occurred, that is, a fault monitoring signal. Hence, the spectrum of the received signal light includes not only a wavelength band λ1 to λm of the main signal light, but also a wavelength of the fault monitoring signal light, that is, any one of wavelengths λS1 to λSn, as illustrated in FIG. 14B.

Accordingly, it is possible for a terminal station to judge whether a fault occurs in any excitation light source, by monitoring whether any one of wavelengths λS1 to λSn is included in the spectrum of the received signal light.

In addition, it is also possible to identify an optic relay unit including the laser diode in which a fault occurred, based on the monitored wavelength. Furthermore, it is also possible to identify an excitation laser diode in which a fault occurs, based on a modulated frequency of a signal light having the monitored wavelength.

Though the wavelengths λS1 to λSn of a fault monitoring signal light are designed to be shorter than the wavelengths λ1 to λm of a main signal light, the wavelengths λS1 to λSn of a fault monitoring signal light may be designed to be longer than the wavelengths λ1 to λm of a main signal light.

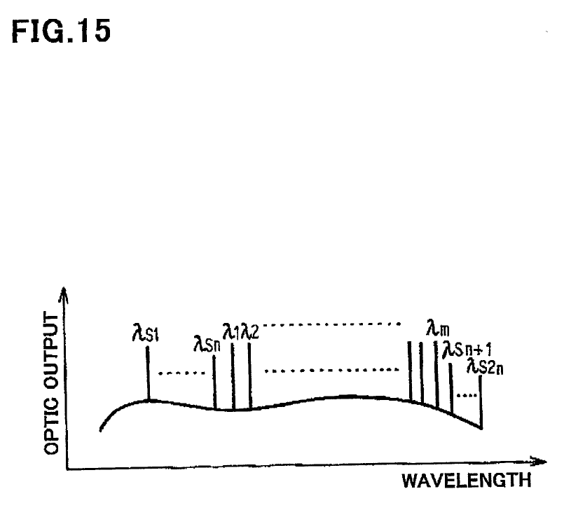

As an alternative, some of the wavelengths λS1 to λSn may be designed to be longer than the wavelengths λ1 to λm of a main signal light, and the others may be designed to be shorter. FIG. 15 shows an example of spectrum of a signal light to be received at a terminal station in the case that some of wavelengths of a fault monitoring signal light are longer than wavelengths of a main signal light, and the others are shorter. Specifically, wavelengths of a fault monitoring signal light are comprised of wavelengths λS1 to λSn shorter than a wavelength band of λ1 to λm of a main signal light, and wavelengths λSn+1 to λS2n longer than a wavelength band of λ1 to λm of a main signal light.

A second example of assignment is for an optic relay unit including four excitation laser diodes.

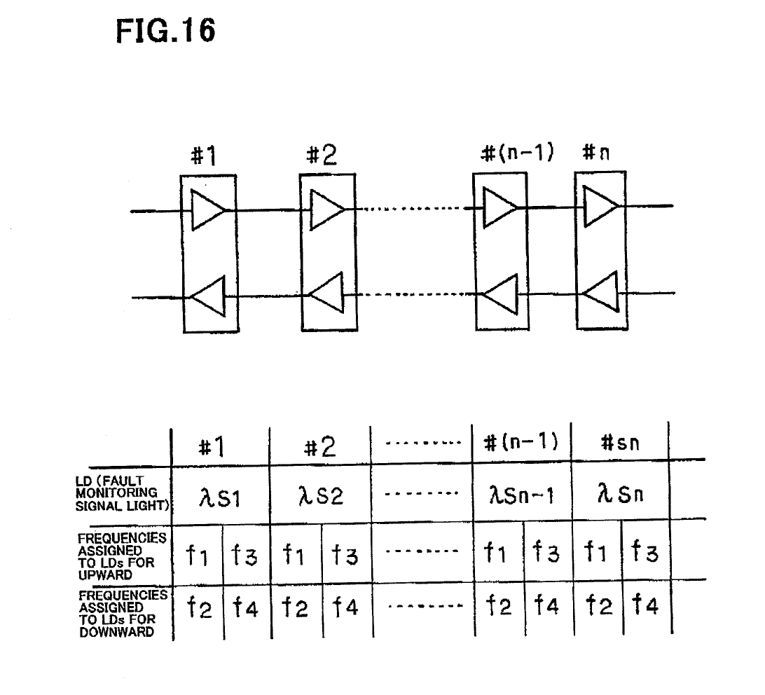

FIG. 16 shows another example of assignment of a frequency to excitation laser diodes in the case that a laser diode for transmitting a fault monitoring signal light in a certain optic relay unit is designed to emit a fault monitoring signal light having a wavelength different from wavelengths of fault monitoring signal lights emitted from laser diodes in other optic relay units. Similarly to the example shown in FIC;. 13, the optic relay units are assigned numbers #1, #2, - - - , #(n-1), and #n. A laser diode in a certain optic relay unit is designed to emit a fault monitoring signal light having a wavelength different from wavelengths of fault monitoring signal lights emitted from laser diodes in other optic relay units. Specifically, laser diodes in the optic relay units #1 to #n are designed to emit a fault monitoring signal light having a wavelength λS1 to λSn, respectively. The wavelengths λS1 to λSn are out of a wavelength band of a main signal light. Frequencies f1 and f2 different from each other are assigned to rear excitation type excitation laser diodes, and frequencies f3 and f4 different from each other are assigned to front excitation type excitation laser diodes. A common frequency is assigned to the optical relay units #1 to #n.

If no faults occur in excitation laser diodes, a terminal station would receive only the main signal light. Hence, the spectrum of the received signal light includes only a wavelength band λ1 to λm of the main signal light (see FIG. 14A).

On the other hand, if a fault occurs in a laser diodes in any one of the optic relay units, a terminal station would receive the main signal light including a signal light having been modulated with a frequency assigned to an excitation laser diode in which a fault occurred, that is, a fault monitoring signal. Hence, the spectrum of the received signal light includes not only a wavelength band λ1 to λm of the main signal light, but also a wavelength of the fault monitoring signal light, that is, any one of wavelengths λS1 to λSn (see FIG. 14B).

Accordingly, it is possible for a terminal station to judge whether a fault occurs in any excitation light source, by monitoring whether any one of wavelengths λS1 to λSn is included in the spectrum of the received signal light.

In addition, it is also possible to identify an optic relay unit including the laser diode in which a fault occurred, based on the monitored wavelength. Furthermore, it is also possible to identify an excitation laser diode in which a fault occurs, based on a modulated frequency of a signal light having the monitored wavelength.

In the above-mentioned light transmission system, any one of the optic encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-120999 filed on Apr. 19, 2001 including specification, claims, drawings and summary is incorporated herein by reference in its entirety.

What is claimed is:

1. An optic relay unit comprising:
(a) an excitation light source to which a predetermined inherent frequency is assigned;
(b) an optical amplifier arranged in a transmission line through which a main signal light having a predetermined wavelength is transmitted, to receive said main signal light, said optical amplifier being excited by an excited light emitted from said excitation light source and amplifying said main signal light; and
(c) a fault monitoring unit which generates a fault monitoring signal light modulated with said predetermined inherent frequency and having a wavelength different from said predetermined wavelength of said main signal light, when a fault occurs in said excitation light source, and transmits said fault monitoring signal light to said transmission line.

2. The optic relay unit as set forth in claim 1, wherein said excitation light source is comprised of a plurality of excitation light-emitting diodes to which inherent frequencies different from one another are assigned, and wherein said fault monitoring unit, when a fault occurs in any one of said excitation light-emitting diodes, generates said fault monitoring signal light modulated with a frequency assigned to an excitation light-emitting diode in which said fault occurs.

3. The optic relay unit as set forth in claim 2, wherein said fault monitoring unit is comprised of:
(a) a light source which emits said fault monitoring signal light;
(b) a first circuit which, on receipt of fault data, transmits a signal having a frequency identified with said fault data;
(c) a second circuit which, on receipt of a control signal, starts driving said light source, and modulates an intensity of said fault monitoring signal light emitted from said light source, with said frequency of said signal transmitted from said first circuit; and
(d) a third circuit which, when a fault occurs in any one of said excitation light-emitting diodes, transmits said fault data to said first circuit and said control signal to said second circuit, said fault data including a frequency assigned to an excitation light-emitting diode in which said fault occurs, said control signal including an instruction to start driving said light source.

4. The optic relay unit as set forth in claim 1, wherein said excitation light source is comprised of a plurality of excitation light-emitting diodes to which a common inherent frequency is assigned and each of which includes a fault monitoring unit, and wherein each of said fault monitoring units, when a fault occurs in a monitored excitation light-emitting diode, generates said fault monitoring signal light modulated with said common inherent frequency said fault monitoring signal light having a wavelength different from wavelengths of fault monitoring lights emitted from the other fault monitoring units.

5. The optic relay unit as set forth in claim 4, wherein each of said fault monitoring units is comprised of:
(a) a light source which emits said fault monitoring signal light;
(b) a first circuit which, on receipt of fault data, transmits a signal having a frequency identified with said fault data;
(c) a second circuit which, on receipt of a control signal, starts driving said light source, and modulates an intensity of said fault monitoring signal light emitted from said light source, with said frequency of said signal transmitted from said first circuit; and
(d) a third circuit which, when a fault occurs in the monitored excitation light-emitting diodes, transmits said fault data to said first circuit and said control signal to said second circuit, said fault data including a frequency assigned to said monitored excitation light-emitting diode in which said fault occurs, said control signal including an instruction to start driving said light source.

6. The optic relay unit as set forth in claim 1, wherein said transmission line is comprised of an upward transmission line and a downward transmission line, and said fault monitoring unit transmits said fault monitoring signal light to both of said upward and downward transmission lines.

7. An optic relay unit comprising,
(a) an excitation light source;
(b) an optical amplifier arranged in a transmission line through which a main signal light having a predetermined wavelength is transmitted, to receive said main signal light, said optical amplifier being excited by an excited light emitted from said excitation light source and amplifying said main signal light; and
(c) a fault monitoring unit which generates a fault monitoring signal light having an wavelength in advance assigned thereto, different from said predetermined wavelength of said main signal light, when a fault occurs in said excitation light source, and transmits said fault monitoring signal light to said transmission line.

8. The optic relay unit as set forth in claim 7, wherein said excitation light source is comprised of a plurality of excitation light-emitting diodes each of which includes a fault monitoring unit, and wherein each of said fault monitoring units, when a fault occurs in a monitored excitation light-emitting diode, generates said fault monitoring signal light having said assigned wavelength which is different from wavelengths of fault monitoring lights emitted from the other fault monitoring units.

9. The optic relay unit as set forth in claim 8, wherein each of said fault monitoring units is comprised of:
(a) a light source emitting a fault monitoring light having a wavelength in advance assigned thereto and inherent thereto;
(b) a first circuit which, on receipt of a control signal, starts driving said light source; and
(c) a second circuit which transmits a signal including an instruction to start driving said light source, to said first circuit as said control signal, when a fault occurs in a monitored excitation light-emitting diode,
wherein said light sources in said fault monitoring units emit lights having wavelengths different from one another.

10. The optic relay unit as set forth in claim 7, wherein said transmission line is comprised of an upward transmission line and a downward transmission line, and said fault monitoring unit transmits said fault monitoring signal light to both of said upward and downward transmission lines.

11. A terminal station receiving a signal light through a transmission line in which at least one optic relay unit is arranged,
said optic relay unit being comprised of:
(a) an excitation light source to which a predetermined inherent frequency is assigned;
(b) an optical amplifier arranged in a transmission line through which a main signal light having a predetermined wavelength is transmitted, to receive said main signal light, said optical amplifier being excited by an excited light emitted from said excitation light source and amplifying said main signal light; and
(c) a fault monitoring unit which generates a fault monitoring signal light modulated with said predetermined inherent frequency and having a wavelength different from said predetermined wavelength of said main signal light, when a fault occurs in said excitation light source, and transmits, said fault monitoring signal light to said transmission line,
said terminal station comprising:
(a) a spectrum detector which detects spectrum of a received signal light; and
(b) a fault identifier which checks whether a wavelength of a fault monitoring signal light transmitted from said optic relay unit is included in said spectrum detected by said spectrum detector, and which, if said wavelength is included in said spectrum, identifies an excitation light source in which a fault occurs, based on said wavelength and a frequency of said fault monitoring signal light.

12. A terminal station receiving a signal light through a transmission line in which at least one optic relay unit is arranged,
said optic relay unit being comprised of;
(a) an excitation light source to which a predetermined inherent frequency is assigned;
(b) an optical amplifier arranged in a transmission line through which a main signal light having a predetermined wavelength is transmitted, to receive said main signal light, said optical amplifier being excited by an excited light emitted from said excitation light source and amplifying said main signal light; and
(c) a fault monitoring unit which generates a fault monitoring signal light modulated with said predetermined inherent frequency and having a wavelength different from said predetermined wavelength of said main signal light, when a fault occurs in said excitation light source, and transmits said fault monitoring signal light to said transmission line,
said terminal station comprising:
(a) a spectrum detector which detects spectrum of a received signal light; and
(b) a fault identifier which checks whether a wavelength of a fault monitoring signal light transmitted from said optic relay unit is included in said spectrum detected by said spectrum detector, and which, if said wavelength is included in said spectrum, identifies an excitation light source in which a fault occurs, based on said wavelength of said fault monitoring signal light.

13. A light transmission system comprising:
(a) a plurality of optic relay units each of which includes an excitation light source to which a frequency different from frequencies assigned to other excitation light sources is assigned, and which transmits a fault monitoring signal light having a frequency modulated with a frequency assigned to an excitation light source in which a fault occurs; and
(b) a terminal station which receives a signal light through said optic relay units, detects spectrum of the thus received signal light, checks whether a wavelength of said fault monitoring signal light transmitted from said optic relay unit is included in the thus detected spectrum, and, if said wavelength is included in said spectrum, identifies an excitation light source in which a fault occurs, based on said frequency of said fault monitoring signal light.

14. A light transmission system comprising:
(a) a plurality of optic relay units each of which includes an excitation light source which transmits a fault monitoring signal light having a wavelength inherent thereto, if a fault occurs in said excitation light source; and
(b) a terminal station which receives a signal light through said optic relay units, detects spectrum of the thus received signal light, checks whether a wavelength of said fault monitoring signal light transmitted from said optic relay unit is included in the thus detected spectrum, and, if said wavelength is included in said spectrum, identifies an excitation light source in which a fault occurs, based on said wavelength of said fault monitoring signal light.

15. A method of identifying an excitation light source in which a fault occurs, in a light transmission system including a transmission line in which a plurality of optic relay units each including an excitation light source is arranged,
said method comprising the steps of:
(a) assigning a frequency to each of the excitation light sources of said optic relay units such that the thus assigned frequencies are different from one another;
(b) transmitting a fault monitoring signal light to said transmission line which fault monitoring signal light has a frequency modulated with a frequency assigned to an excitation light source in which a fault occurs;
(c) detecting spectrum of a signal light received through said transmission line; and
(d) checking whether a wavelength of said fault monitoring signal light is included in said spectrum detected in said step (c), and, if said wavelength is included in said spectrum, identifying an excitation light source in which a fault occurs, based on said frequency of said fault monitoring signal light.

16. A method of identifying an excitation light source in which a fault occurs, in a light transmission system including a transmission line in which a plurality of optic relay units each including an excitation light source is arranged,
said method comprising the steps of:
(a) transmitting a fault monitoring signal light to said transmission line which fault monitoring signal light has a wavelength if a fault occurs in an excitation light source, said wavelength being inherent to said excitation light source;
(b) detecting spectrum of a signal light received through said transmission line; and
(c) checking whether a wavelength of said fault monitoring signal light is included in said spectrum detected in said step (b), and, if said wavelength is included in said spectrum, identifying an excitation light source in which a fault occurs, based on said wavelength of said fault monitoring signal light.
